(19) United States
(12) Patent Application Publication
(10) Pub. No.: US 2009/0315822 A1
(43) Pub. Date: Dec. 24, 2009

(54) FUNCTIONALLY INTEGRATED LCD DISPLAYS WITH OLED BACKLIGHT

(75) Inventors: Alexander Biebel, Bickenbach (DE); Rainer Neeff, Neu-Isenburg (DE)

Correspondence Address: CONNOLLY BOVE LODGE & HUTZ, LLP, P O BOX 2207, WILMINGTON, DE, 19899, US

(73) Assignee: Merck Patent GmbH, Darmstadt (DE)

(21) Appl. No.: 12/301,247

(22) PCT Filed: Apr. 23, 2007
(86) PCT No.: PCT/EP2007/003536

§ 371 Date: Nov. 18, 2008

(30) Foreign Application Priority Data
May 18, 2006 (DE) 10 2006 023 658.0

(51) Int. Cl. G09G 3/36; G02F 1/13357

(52) U.S. Cl. 345/102; 362/97.2; 313/504

(57) ABSTRACT

The present invention relates to an LCD display with an OLED backlight, which is characterized in that the OLED backlight has, alongside the areal region serving for backlighting the LCD display, one or a plurality of additional regions which can be switched independently of the areal region and which serve for representing information, and the use thereof.

The present invention relates to functionally integrated liquid-crystal displays (LCDs) with OLED (organic light emitting diode) backlight, and to the use thereof.

In recent years, LCD displays have undergone rapid development. Whether in mobile telephones, laptops, palms, navigation systems, measuring instruments and display devices of all types, notebooks, monitors and televisions, liquid crystals (LCs) can be found in displays of virtually all electronic equipment. Electronic equipment of this type furthermore includes measuring instruments, communication devices, imaging devices, gaming devices, heating and cooling appliances, watches, devices in domestic electronics and small domestic appliances. In addition, liquid crystals are used, for example, in displays for the display of information in automobiles, trains, aircraft, ships and machines and inside and outside buildings.

At present, LCD displays are generally illuminated using LEDs (light-emitting diodes) or CCFLs (cold cathode fluorescence lamps). For the illumination of LCD displays, these are generally coupled into an optical waveguide, in particular if a flat structure is necessary and/or desired. In general, the optical waveguide is coupled to LEDs/CCFLs at the side. The light coupled out of the surface then exits through the centres of scattering applied to the optical waveguide. However, structured exit of light which can be switched region by region is not possible in this way.

The use of OLEDs as backlight in LCD displays is described in a large number of publications and patent applications. However, products of this type are currently not yet commercially available.

Thus, LCD displays with OLED backlights are described, for example, in WO 99/54780 A1, US 2004/0164292 A1 and US 2005/0007517 A1. The use of OLED backlights enables reflective, transflective and transparent LCD displays having a thin structure to be achieved.

US 2006/0066227 A1 discloses an electronic device having two viewing windows which includes a display module comprising a first and second display, where the first display (for example an LCD) is visible through the first viewing window and the second display (for example an OLED) is visible through the second viewing window. The light emitted by the second display serves as backlight for the first display. The OLED serves exclusively as backlight for the LCD.

DE 101 39 854 A1 describes a display device having an LCD (liquid-crystal display), which is characterised in that the LCD is combined with a polyLED (polymer luminance electronic device) display or an OLED (organic luminance electronic device) display. However, the polyLED or the OLED serves exclusively for more uniform and improved illumination. This is achieved in that the polyLED display or the OLED display has an unstructured design.

WO 2005/011293 A1 discloses a display which can be employed both as 2D and also as 3D display. This display has a light source (for example an OLED) and an arrangement of modulators which modulate the light intensity. The OLED as light source can be either unstructured or structured. However, the light source serves exclusively as backlight.

It is disadvantageous in the known LCD displays, both with LED or CCFL backlights and also with OLED backlights, that all the information is made available merely via the LCD display, while the backlight merely has the function of backlighting the LCD display.

Consequently, it can be regarded as an object of the present invention to provide LCD displays with OLED backlights which do not have the described disadvantages of the prior art and can be used to provide additional information via the LCD display.

This object is achieved in accordance with the invention by an LCD display which has a structured OLED backlight, i.e. an OLED backlight which has one or more regions which are visible to or resolvable by the human eye and can be addressed sequentially and thus can be switched selectively.

The present invention thus relates to an LCD display with an OLED backlight, which is characterised in that the OLED backlight, besides the areal region which serves for backlighting the LCD display, has one or more additional regions which can be switched independently of the areal region and which serve for the display of information.

In this way, it is possible for information to be provided not only via the LCD display, but instead additionally via the OLED backlight.

The general structure and mode of functioning of an LCD display are known to the person skilled in the art. The construction can take place in any way known to the person skilled in the art and is in no way restricted. It is described, for example, in “Displays” by P. M. Knoll, A. Hüthing Verlag, Heidelberg.

The construction of the OLED backlight can also be carried out in any way known to the person skilled in the art. The OLED generally has a glass or plastic substrate which is coated with a transparent electrode, such as, for example, indium tin oxide (“ITO”). Coated substrates of this type are commercially available. This coated substrate is coated with at least one layer of a thin film of electroluminescent organic material and a further layer which forms the second electrode and is generally a metal or alloy. In addition, the OLED backlight can have further layers, such as, for example, hole- and/or electron-transport layers, and optionally further layers which improve, for example, the charge transport between the electrodes and the electroluminescent material.

Light-emitting materials which can be employed in the OLEDs here are both low-molecular-weight compounds (so-called “small molecules”), and also polymers, as described, for example, in WO 90/13148 A1 and U.S. Pat. No. 4,539,507. In addition, the OLED can have either a monochromatic or poly-chromatic design, for example through the use of red, green or blue luminescent polymers and through the use of coloured or white OLEDs and corresponding coloured filters.

The OLED backlight according to the invention is characterised merely by the fact that it has one or more regions which can be switched independently of the remaining areal region which serves for backlighting the LCD display.

Since the at least one additional region is intended to be employed for the display of information, its size must be visible to or resolvable by the human eye. The size of the at least one additional region is preferably at least 4 mm², particularly preferably at least 25 mm² and in particular at least 64 mm².

The at least one additional region can differ with respect to the brightness, colour and/or shape from the areal region which serves for backlighting the LCD.

In addition, the at least one additional region can be arranged in any desired manner in the areal region which serves for backlighting.

In a preferred embodiment, the at least one additional region is arranged in the OLED backlight in such a way that it is located behind the LCD display. In this way, the desired information can be superimposed directly onto the LCD display.

In a further preferred embodiment, the OLED backlight has a larger area than the LCD display. In this case, it is possible to arrange the at least one additional region at the side, above and/or below the LCD display. In this way, the desired information can be displayed, for example, alongside the LCD display.

A combination of the two preferred embodiments is of course also possible, i.e. there is at least one additional region which is arranged behind the LCD display and at least one region which is arranged above, below or alongside the LCD display.

Both the LCD displays and also the OLED backlights can be produced by all processes known to the person skilled in the art.

In a further preferred embodiment, the OLED is arranged behind the LCD in such a way that incident sunlight is reflected at the metallic cathode of the OLED, and the LCD can be utilised for scattering the reflected light. Different regions of the OLED or LCD can, in accordance with the invention, have different degrees of reflection and thus brightnesses.

In a further embodiment, however, the cathode of the OLED can also be designed in such a way that reflection at it can be substantially avoided. The incident sunlight is in this case not reflected or reflected to a greatly reduced extent.

The present invention furthermore relates to the use of the LCD displays with OLED backlights according to the invention. In all cases, they can be employed instead of known LCD displays. However, preferred applications are in display screens, such as, for example, PC monitors, notebooks, laptops and televisions, in mobile entertainment electronics, such as, for example, PDAs, games consoles, mobile telephones, watches and S calculators, and in display and/or control elements, for example in automobiles (such as, for example, in vehicle instrument displays and in vehicle gearsticks), trains, ships and aircraft. Further possible applications as display and control elements are found in domestic appliances and garden equipment, in measuring instruments and machines, in mobile and fixed medical technology, such as, for example, in thermometers and blood-sugar measuring equipment, in buildings, for example in house communication systems, switches, lights, signs and path control systems, and in sport and leisure equipment, for example in home trainers.

The invention is explained in greater detail below with reference to preferred embodiments, but without being restricted thereby.

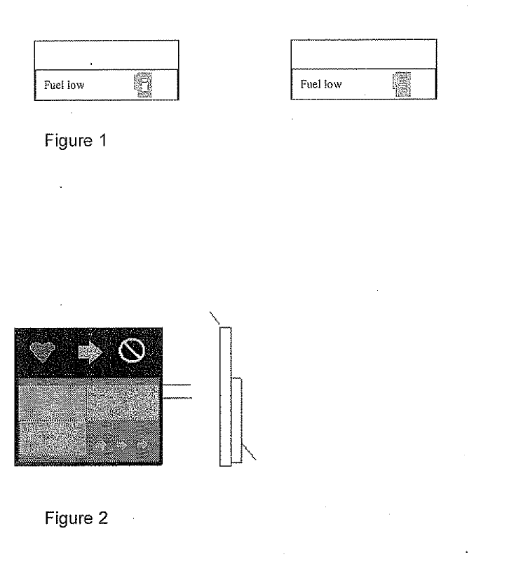

FIG. 1 shows symbolically a TN cell in an automobile instrument display. The text information “Fuel low” is displayed via the LCD display. The corresponding symbol is additionally displayed via the at least one additional region of the OLED backlight according to the invention, for example in a different colour from the normal backlight. In addition, for example, the fuel level can likewise be displayed above the tank symbol by small LCD bars which come from the OLED backlight.

FIG. 2 shows symbolically a further preferred embodiment in which the OLED backlight has a larger area than the LCD display. In this case, additional regions are arranged both above and also within the LCD display.

1.-13. (canceled)

14. An LCD display comprising an OLED backlight, which includes an areal region adapted to serve as a backlight for the LCD display and one or more additional regions adapted to be switched independently of the areal region and to display information.

15. The LCD display according to claim 14, wherein one of the additional regions is at least 4 mm² in size.

16. The LCD display according to claim 1, wherein one of the additional regions differs in at least one of brightness, colour, and shape as compared to the areal region.

17. The LCD display according to claim 1, wherein one of the additional regions is arranged in the OLED backlight in such a way that it is located on a backside of the LCD display.

18. The LCD display according to claim 1, wherein one of the additional regions is arranged on one of a side, above or below the LCD display.

19. The LCD display according to claims 4, wherein a first of the additional regions is arranged in the OLED backlight in such a way that it is located on a backside of the LCD display, and a second of the additional regions is arranged on one of a side, above or below the LCD display.
